(19) United States
(12) Patent Application Publication
(10) Pub. No.: US 2025/0102811 A1
(43) Pub. Date: Mar. 27, 2025

(54) ADJUSTMENT DEVICE AND HEAD-MOUNTED DEVICE HAVING THE SAME

(71) Applicant: Beijing Zitiao Network Technology Co., Ltd., Beijing (CN)

(72) Inventor: Zishang WANG, Beijing (CN)

(21) Appl. No.: 18/730,219

(22) PCT Filed: Jan. 6, 2023
(86) PCT No.: PCT/CN2023/070942

§ 371 Date: Jul. 18, 2024

(30) Foreign Application Priority Data
Jan. 18, 2022 (CN) 202210056355.7

(51) Int. Cl. G02B 27/01

(52) U.S. Cl. CPC G02B 27/0176; G02B 2027/0154

(57) ABSTRACT

An adjustment device and a head-mounted device having the same are provided. The adjustment device includes: a housing, two bands, a knob, a ratchet and a gear; the housing is provided with a mounting space and an inner ring gear; the two bands are movably arranged on the housing respectively and fitting with the housing to define a wearing space, each of the bands being provided with a fitting rack; the knob is rotatably mounted inside the mounting space and provided with a first driving portion; the ratchet and the gear rotating synchronously and both are rotatably arranged on the knob, the gear meshing with the fitting rack on the two bands to drive the bands to move away from or towards each other, the ratchet being provided with a swing arm that is provided with ratchet teeth.

### CROSS REFERENCE TO RELATED APPLICATION(S)

The present application claims priority to Chinese Application No. 2022100563557 filed on Jan. 18, 2022, the disclosure of which is incorporated herein by reference in its entity.

### FIELD

The present application relates to a technical field of head-mounted devices, and in particular, to an adjustment device and a head-mounted device having the same.

### BACKGROUND

In the field of virtual reality technology, virtual-reality interaction is usually implemented using VR devices. Most of existing head-mounted VR devices adopt a strap adjustment structure. Users can adjust the size of the wearing part of the head-mounted VR device according to their personal situation, so that the head-mounted VR device can fit a head contour of the user. However, the strap adjustment structure is inconvenient to operate, and adjustments of the user involve complicated operations, which is a waste of time. Therefore, a problem which the present application aims to solve relates to an easy-to-operate adjustment structure applied to a head-mounted VR device.

### SUMMARY

The present application aims to solve at least one of technical problems existing in prior art. To this end, an objective of the present application is to propose an adjustment device. With the adjustment device according to the present application, size of a wearing space is adjusted through a gear and a rack. The operation is simple, time-saving and convenient. A knob is arranged inside a housing, which does not occupy any space.

The present application further proposes a head-mounted device having the above-mentioned adjustment device.

The adjustment device according to the present application includes: a housing, provided with a mounting space and an inner ring gear; two bands, movably arranged on the housing respectively and fitting with the housing to define a wearing space, each of the bands being provided with a fitting rack; a knob, rotatably mounted inside the mounting space and provided with a first driving portion; a ratchet and a gear, the ratchet and the gear rotating synchronously and both rotatably arranged on the knob, the gear meshing with the fitting rack on the two bands to drive the bands to move away from or towards each other, the ratchet being provided with a swing arm that is provided with ratchet teeth; when the knob rotates in a first direction, the first driving portion drives the swing arm to move to detach the ratchet teeth from the inner ring gear, and the knob drives the ratchet to rotate; and when the knob rotates in a second direction opposite to the first direction, the ratchet teeth fit with the inner ring gear, and the knob drives the ratchet to rotate.

In the adjustment device involved in the present application, the knob is arranged inside the mounting space to reduce space occupied by the adjustment device. The size of the wearing space can be adjusted by rotating the knob. By using a ratchet provided with a movable swing arm, the adjustment device can adjust the dimensions of the band only during user operation. The structure is stable. When using the adjustment device, user only needs to rotate the knob without any other steps. The operation is simple and user-friendly.

According to some embodiments of the present application, an outer surface of the knob is no higher than an outer surface of the housing.

According to some embodiments of the present application, a fitting protrusion is arranged on the knob, a fitting groove is arranged on the ratchet, and the fitting protrusion protrudes into the fitting groove to drive the ratchet to rotate.

According to some embodiments of the present application, each of the bands is provided with a long hole, the long hole penetrates the band in a thickness direction of the band and extends in a length direction of the band, and the fitting rack is arranged on an inner wall of the long hole.

According to some embodiments of the present application, the ratchet is provided with a non-circular assembling hole, the gear is provided with a non-circular fitting post, and the fitting post fits with the assembling hole to cause the gear and the ratchet to rotate synchronously.

According to some embodiments of the present application, the knob includes an external rotating portion and an internal rotating portion, the external rotating portion is rotatably arranged inside the mounting space, the internal rotating portion and the external rotating portion rotate synchronously, a part of the housing is clamped between the external rotating portion and the internal rotating portion, and the first driving portion is arranged on the internal rotating portion.

According to some embodiments of the present application, the external rotating portion is provided with a fitting protrusion that extends inwardly, at least a part of the fitting protrusion is non-circular, the internal rotating portion is provided with a non-circular fitting hole, and the fitting protrusion fits with the fitting hole to cause the external rotating portion and the internal rotating portion to rotate synchronously.

According to some embodiments of the present application, the adjustment device further including an anti-detachment member that fits with the fitting protrusion and is located on an inner side of the internal rotating portion to prevent the internal rotating portion from falling off.

According to some embodiments of the present application, one of the internal rotating portion and the ratchet is provided with a hook portion, and the other of the internal rotating portion and the ratchet is provided with a stop surface, the hook portion is hooked on the stop surface.

The following is a brief description of a head-mounted device according to another aspect of the present application.

The head-mounted device according to the present application comprises the adjustment device according to any one of the above embodiments. With the adjustment device of the above-mentioned embodiments, the head-mounted device of the present application occupies a small space and has a beautiful appearance. The wearing dimensions of the head-mounted device can be adjusted according to different needs of different users, which is easy to operate. Furthermore, the head-mounted device is suitable for users of various ages.

In summary, the adjustment device according to the embodiments of the present application arranges the knob inside the housing, which greatly reduces the space occupied by the adjustment device and beautifies the appearance of the adjustment device; the user can adjust the area of the wearing space simply by operating the external rotating portion of the knob, which operation is simple and easy to use; by arranging the ratchet and the first driving portion, the adjustment device can have a locking function to prevent the band from moving on its own and changing the area of the wearing space. The structure is more reliable.

Additional aspects and advantages of the application will be set forth in part in the description below, and in part will be obvious from the description, or may be learned by practice of the present application.

### BRIEF DESCRIPTION OF THE DRAWINGS

The above and/or additional aspects and advantages of the present application will become apparent and readily understood from the description of embodiments in conjunction with the following drawings, in which:

FIG. 1 is an overall diagram of an adjustment device according to embodiments of the present application;

FIG. 2 is an exploded view of an adjustment device from which bands are detached according to embodiments of the present application;

FIG. 3 is a structural diagram of a housing portion of according to embodiments of the present application;

FIG. 4 is a structural diagram of an external rotating portion according to embodiments of the present application;

FIG. 5 is a structural diagram of an internal rotating portion according to embodiments of the present application;

FIG. 6 is a structural diagram where bands and anti-detachment member are mounted according to embodiments of the present application;

FIG. 7 is a structural diagram of a ratchet according to embodiments of the present application;

FIG. 8 is a structural diagram of a ratchet according to embodiments of the present application;

FIG. 9 is a structural diagram where a knob, anti-detachment member and ratchet are mounted according to embodiments of the present application;

FIG. 10 is a structural diagram of a gear according to embodiments of the present application;

FIG. 11 is a structural diagram where a knob, anti-detachment member, ratchet and gear are mounted according to embodiments of the present application; and

FIG. 12 is a structural diagram of a band according to embodiments of the present application.

### REFERENCE SIGNS

1 adjustment device; 10 housing; 10a mounting space; 11 inner ring gear;
20 band; 20a long hole; 21 fitting rack;
30 knob; 31 external rotating portion; 311 fitting protrusion; 32 internal rotating portion;
32a fitting hole; 321 first driving portion; 322 fitting protrusion; 323 hook portion;
40 ratchet; 40a assembling hole; 41 swing arm; 41a fitting groove; 411 ratchet; 42 stop surface;
50 gear; fitting 51 post; 60 anti-detachment member.

### DETAILED DESCRIPTION

Embodiments of the present application will be described in detail below. Examples of the embodiments are shown in the accompanying drawings, wherein the same or similar reference numerals represent the same or similar elements or elements with the same or similar functions throughout the figures. The embodiments to be described with reference to the drawings below are exemplary and are only used to explain the present application and cannot be construed as limiting the present application.

In the description of the present application, it should be understood that the orientations or positional relationships indicated by the terms “center”, “longitudinal”, “transverse”, “length”, “width”, “thickness”, “upper”, “lower”, “front”, “back”, “left”, “right”, “vertical”, “horizontal”, “top”, “bottom”, “inside”, “outside” and the like are based on the orientations or positional relationships shown in the accompanying drawings, are only for the convenience of describing the present application and simplifying the description rather than indicating or implying that the device or element referred to must have a specific orientation or be constructed and operated in a specific orientation, and therefore should not be construed as limiting the present application.

In addition, the terms “first” and “second” are used for descriptive purposes only and should not be construed as indicating or implying relative importance or implicitly indicating the quantity of indicated technical features. Therefore, features defined as “first” and “second” may explicitly or implicitly include one or more of these features. In the description of the present application, “plurality” means at least two, such as two, three, etc., unless otherwise expressly and specifically limited.

In the present application, unless otherwise explicitly stated and limited, the terms “install”, “connected”, “connect”, “fix” and other terms should be understood in a broad sense. For example, it can be a fixed connection or a detachable connection, or integrated; it can be a mechanical connection, an electrical connection or mutual communication; it can be directly connected, or indirectly connected through an intermediate medium, or it can be a connection within two elements or the mutual interaction between two elements. For those of ordinary skill in the art, they may understand the specific meanings of the above terms in the present application according to specific circumstances.

In the present application, unless otherwise explicitly stated and limited, a first feature being “above” or “below” a second feature may include the first feature and the second feature being in direct contact, or may include the first feature and the second feature not being in direct contact but being in contact through another feature. Moreover, the first feature being “above,” “over” or “on” a second feature includes the first feature being directly above and diagonally above the second feature, or simply indicates that the first feature is horizontally higher than the second feature. The first feature being “below”, “under” or “beneath” the second feature includes the first feature being directly below and diagonally below the second feature, or simply indicates that the first feature is horizontally shorter than the second feature.

In the field of virtual reality technology, virtual-reality interaction is usually implemented using VR devices. Most of existing head-mounted VR devices adopt a strap adjustment structure. Users can adjust the size of the wearing part of the head-mounted VR device according to their personal situation, so that the head-mounted VR device can fit a head contour of the user. However, the strap adjustment structure is inconvenient to operate, and adjustments of the user involve complicated operations, which is a waste of time. Therefore, a problem which the present application aims to solve relates to an easy-to-operate adjustment structure applied to a head-mounted VR device.

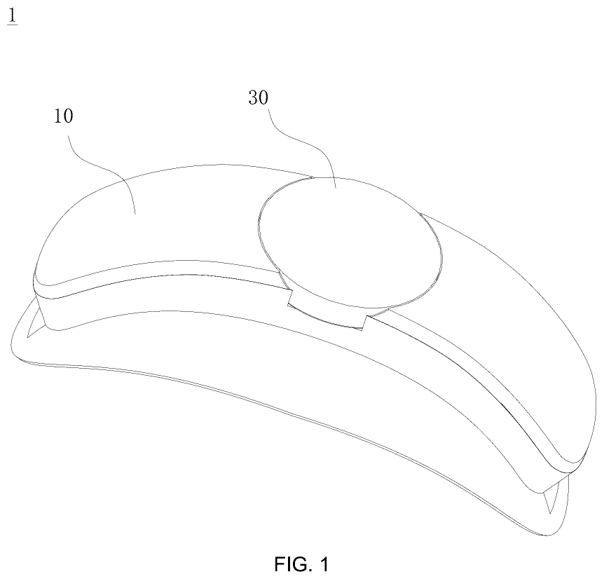

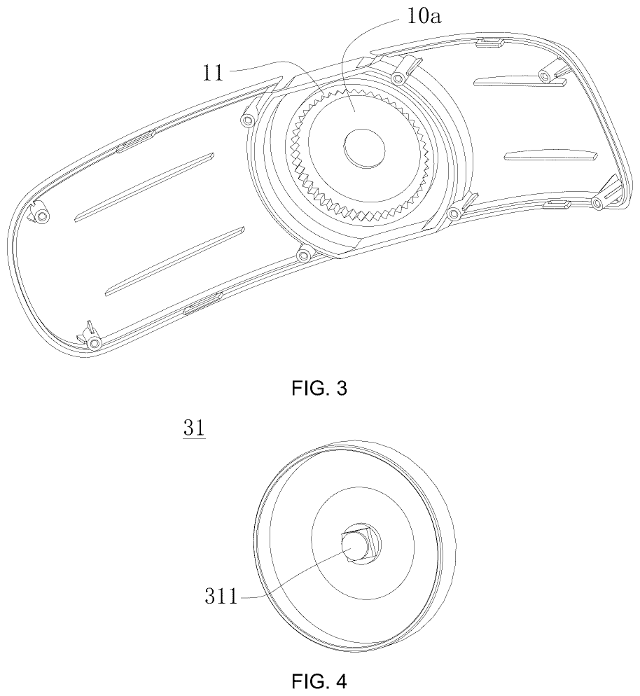

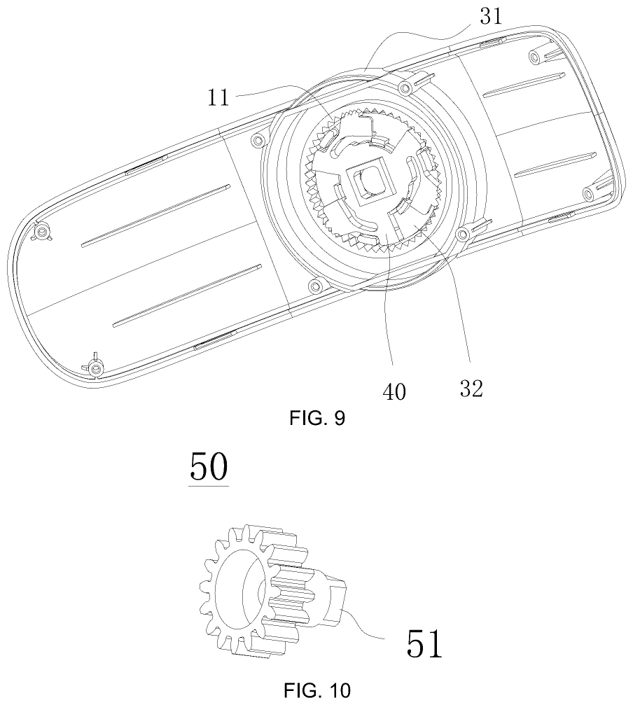

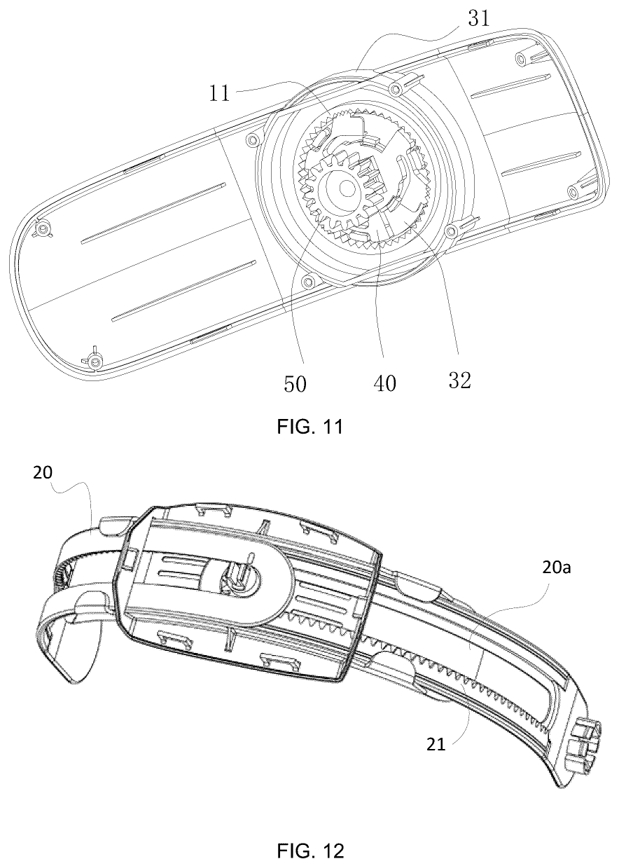

An adjustment device 1 according to the embodiments of the present application is described below with reference to FIGS. 1 to 12.

As shown in FIG. 1, the adjustment device 1 according to the present application includes: a housing 10, two bands 20, a knob 30, a ratchet 40 and gear 50. The housing 10 is provided with a mounting space 10a, and the housing 10 is provided with an inner ring gear 11; the two bands 20 are respectively movably arranged on the housing 10 and define a wearing space in cooperation with the housing 10. A fitting rack 21 is arranged on each band 20; the knob 30 is rotatably mounted in the mounting space 10a and is provided with a first driving portion 321; the ratchet 40 and the gear 50 rotate synchronously and are both rotatably arranged on the knob 30; the gear 50 meshes with the fitting racks 21 on the two bands 20 to drive the bands 20 to move backward or towards each other. The ratchet 40 is provided with a swing arm 41, which is provided with ratchet teeth 411; when the knob 30 rotates in a first direction, the first driving portion 321 drives the swing arm 41 to move to detach the ratchet teeth 411 from the inner ring gear 11, and the knob 30 drives the ratchet 40 to rotate; when the knob 30 rotates in a second direction opposite to the first direction, the ratchet teeth 411 fit with the inner ring gear 11, and the knob 30 drives the ratchet 40 to rotate.

Specifically, the band 20 can extend out of the housing 10, and the user can adjust the extension length of the band 20 by rotating the knob 30, so as to adjust the size of the band 20 to a length that is suitable for the user to wear. The housing 10 can be used as an appearance surface of the adjustment device 1. The bands 20, the knob 30, the ratchet 40 and the gear 50 are arranged at the housing 10, wherein the knob 30, the ratchet 40 and the gear 50 can drive the bands 20 to move, and the knob 30 can rotate in two directions, and the two bands 20 can be moved towards or away from each other by rotating the knob 30. The two rotation directions of the knob 30 are the first direction and the second direction respectively, and the first direction and the second direction are opposite to each other. Since the ratchet 40 and the gear 50 rotate synchronously, the ratchet 40 cannot rotate in both directions when the ratchet 40 fits with the inner ring gear 11 on the housing 10. Under the circumstances described in the present application, the ratchet 40 can rotate in the second direction but cannot rotate in the first direction. The ratchet 40 described in the present application is provided with the swing arm 41 on which the ratchet teeth 411 are formed. The first driving portion 321 on the knob 30 can drive the swing arm 41 to move to realize the detachment of the ratchet teeth 411 from the inner ring gear 11, so that the ratchet 40 can rotate in the first direction and further the ratchet 40 can drive the gear 50 to rotate in two directions.

More specifically, the principle that the knob 30 drives the band 20 to move is that the knob 30 is provided with the rotatable ratchet 40 and gear 50, wherein the gear 50 meshes with the fitting rack 21 on the band 20 to drive the band to move. The two bands 20 can move towards each other to reduce the wearing space, or can move away from each other to increase the wearing space.

When the user rotates the knob 30 towards the first direction, the ratchet teeth 411 fit with the inner ring gear 11, and the ratchet 40 cannot rotate towards the first direction. At this time, the first driving portion 321 drives the swing arm 41 to move, so that the ratchet teeth 411 are detached from the inner ring gear 11, the ratchet 40 can rotate and drive the gear 50 to rotate, and the gear 50 drives the two bands 20 to move towards each other. When the user rotates the knob 30 towards the second direction, the ratchet teeth 411 fit with the inner ring gear 11. At this time, the ratchet 40 can rotate towards the second direction, the knob 30 can drive the ratchet 40 to rotate in the second direction, and the gear 50 drives the two bands 20 to move away from each other. It can be understood that when the knob 30 rotates in the first direction, the two bands 20 can also move away from each other. Similarly, when the knob 30 rotates in the second direction, the two bands 20 can also move towards each other.

When the knob 30 is not rotated, the ratchet 40 fits with the inner ring gear 11 to lock the gear 50 that rotates synchronously with the ratchet 40. At this time, the gear 50 cannot rotate, so that the band 20 cannot move. That is, the ratchet 40 is arranged to provide the adjustment device 1 with a locking function to prevent the band 20 from moving on its own to cause the wearing size of the headgear to change.

In the adjustment device 1 involved in the present application, the knob 30 is arranged in the mounting space 10a, which reduces the space occupied by the adjustment device 1. The size of the wearing space can be adjusted by rotating the knob 30. By applying the ratchet 40 provided with the swing arm 41, the adjustment device 1 is caused to adjust the size of the band 20 only during the user operation, achieving a stable structure. When using the adjustment device 1, the user only needs to rotate the knob 30 without any other steps. The operation is simple and convenient.

According to some embodiments of the present application, as shown in FIG. 1, an outer surface of the knob 30 is not higher than an outer surface of the housing 10. Specifically, in order to reduce the space occupied by the adjustment device 1, the knob 30 can be disposed inside the housing 10 or serve as the outer surface of the housing 10. In some embodiments of the present application, the outer surface of the knob 30 is flush with the outer surface of the housing 10, beautifying the appearance of the adjustment device 1. Meanwhile, a side surface of the knob 30 protrudes from a side surface of the housing 10. The user can adjust an area of the wearing space by rotating a part of the knob that protrudes from the housing 10, which is easy to operate.

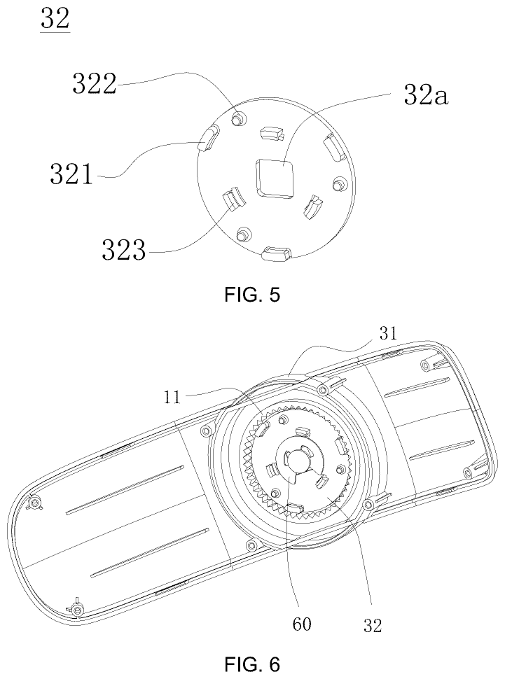

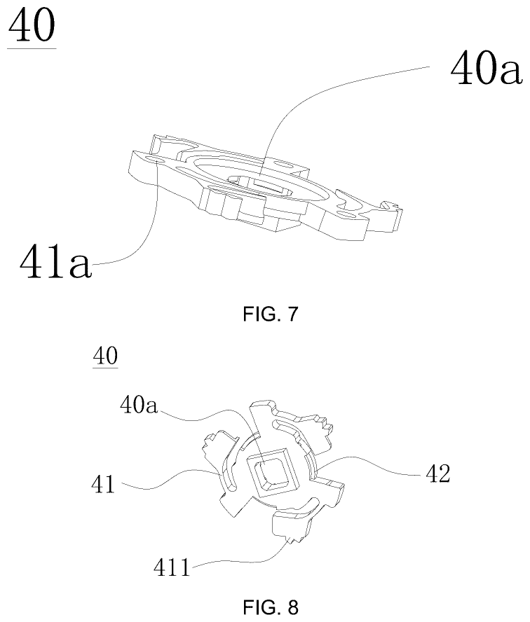

According to some embodiments of the present application, as shown in FIGS. 5 and 7, the knob 30 is provided with a fitting protrusion 322, the ratchet 40 is provided with a fitting groove 41a, and the fitting protrusion 322 extends into the fitting groove 41a to drive the ratchet 40 to rotate. Specifically, the ratchet 40 can be connected to the knob 30 provided with the fitting protrusion 322 through the fitting groove 41a. Through the fit between the fitting protrusion 322 and the fitting groove 41a, the ratchet 40 and the gear 50 can also rotate while the knob 30 rotates. More specifically, the fitting protrusion 322 is in clearance fit with the fitting groove 41a so that the ratchet 40 and the knob 30 can rotate relative to each other. Thus, the driving portion 321 on the knob 30 can selectively contact the swing arm 41 of the ratchet 40, and when the knob 30 rotates to the first driving portion 321 to contact the swing arm 41 of the ratchet 40, the ratchet 40 is detached from the inner ring gear 11. At this time, the ratchet 40 can rotate in the first direction. When the knob 30 is rotated until the fitting protrusion 322 stops against an inner wall of the groove 41a, the ratchet 40 rotates in the second direction under the acting force of the fitting protrusion 322. In some embodiments of the present application, the fitting protrusion 322 is a cylindrical protrusion extending toward the ratchet 40 on the inner surface of the knob 30, the fitting groove 41a is a round hole on the swing arm 41 of the ratchet 40, and the size of the cylindrical protrusion is smaller than that of the round hole.

According to some embodiments of the present application, as shown in FIG. 12, each band 20 is provided with a long hole 20a, the long hole 20a penetrates the band 20 in the thickness direction of the band 20 and extends in the length direction of the band 20, and the fitting rack 21 is arranged on an inner wall of the long hole 20a. Specifically, the two bands 20 have the same construction. In order to facilitate the movement of the band 20, the long hole 20a is provided in the length direction of the band 20. The long hole 20a is provided as penetrating the band 20, and the fitting rack 21 is arranged inside the long hole 20a. In the adjustment device 1, the position of the gear 50 is fixed, and the fitting rack 21 on the band 20 can mesh with the gear 50 and make the band 20 move in the length direction. It can be understood that the movement distance of the two bands 20 remains the same all the time.

According to some embodiments of the present application, as shown in FIGS. 8 and 10, the ratchet 40 is provided with a non-circular assembling hole 40a, and the gear 50 is provided with a non-circular fitting post 51, the fitting post 51 fits with the assembling hole 40a to make the gear 50 and the ratchet 40 rotate synchronously. Specifically, in order to enable the ratchet 40 and the gear 50 to be connected and rotate synchronously, a non-circular shaft hole fit should be used between the ratchet 40 and the gear 50. In some embodiments of the present application, the ratchet 40 is provided with a rectangular assembling hole 40a, the gear 50 is provided with a rectangular fitting post 51, and the rectangular fitting hole 40a is exactly the same size as the rectangular fitting post 51.

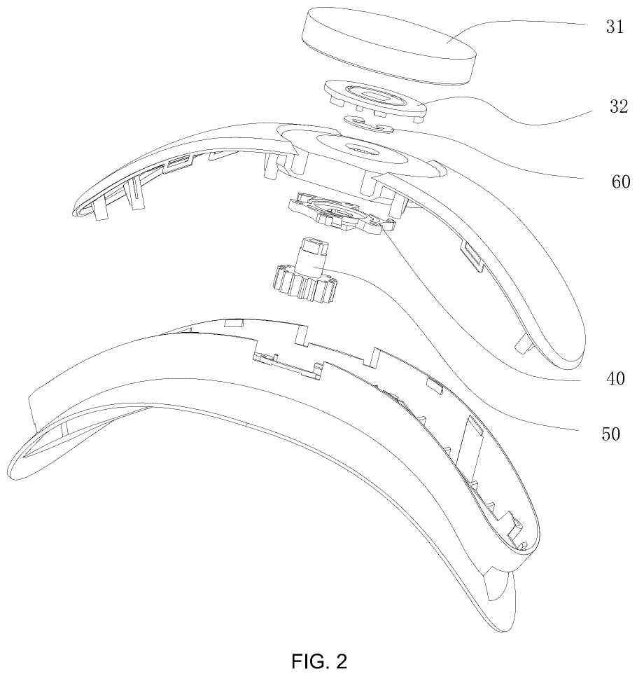

According to some embodiments of the present application, as shown in FIGS. 2 and 4-6, the knob 30 includes an external rotating portion 31 and an internal rotating portion 32, and the external rotating portion 31 is rotatably arranged in the mounting space 10a. The internal rotating portion 32 and the external rotating portion 31 rotate synchronously, a part of the housing 10 is clamped between the external rotating portion 31 and the internal rotating portion 32, and the first driving portion 321 is arranged in the internal rotating portion 32. Specifically, an outer surface of the external rotating portion 31 can be used as part of the outer surface of the housing 10, and the user can rotate the external rotating portion 31; the internal rotating portion 32 is disposed inside the external rotating portion 31, and the internal rotating portion 32 contacts and drives the ratchet 40 to rotate. More specifically, an inner surface of the internal rotating portion 32 is provided with the first driving portion 321 and the fitting protrusion 322, wherein the fitting protrusion 322 fits with the fitting groove 41a on the ratchet 40 to connect the knob 30 and the ratchet 40, while the ratchet 40 can rotate together with the internal rotating portion 32; the first driving portion 321 contacts the swing arm 41 on the ratchet 40 to change the fitting state of the ratchet teeth 411 on the ratchet 40 and the inner ring gear 11 in the housing 10. The external rotating portion 31 can be engaged with a part of the housing 10. The knob 30 provided with the external rotating portion 31 and the internal rotating portion 32 has a simple structure and is not easy to fall off from the housing 10.

According to some embodiments of the present application, as shown in FIGS. 4-6, the external rotating portion 31 is provided with a fitting protrusion 311 that extends inwardly, and at least a part of the fitting protrusion 311 is non-circular, and the internal rotating portion 32 is provided with a non-circular fitting hole 32a. The fitting protrusion 311 fits with the fitting hole 32a to allow the external rotating portion 31 and the internal rotating portion 32 to rotate synchronously. Specifically, in order to enable the internal rotating portion 32 and the external rotating portion 31 of the knob 30 to be connected and rotate synchronously, a non-circular shaft hole fit should be used between the internal rotating portion 32 and the external rotating portion 31, wherein the inner surface of the external rotating portion 21 is provided with a fitting protrusion 311, a part of the fitting protrusion 311 is a non-circular protrusion, and the internal rotating portion 32 is provided with a non-circular fitting hole 32a. In some embodiments of the present application, the external rotating portion 31 is provided with a partly rectangular fitting protrusion 311, the internal rotating portion 32 is provided with a rectangular fitting hole 32a, and the rectangular part of the fitting protrusion 311 coincides with the dimensions of the rectangular fitting hole 32a.

According to some embodiments of the present application, as shown in FIGS. 2 to 6, the adjustment device 1 further includes an anti-detachment member 60. The anti-detachment member 60 fits with the fitting protrusion 311 and is located inside the internal rotating portion 32 to prevent the internal rotating portion 32 from falling off. Specifically, the fit between the non-circular part of the fitting protrusion 311 and the non-circular fitting hole 32a can only cause the external rotating portion 31 and the internal rotating portion 32 to rotate synchronously. By arranging the anti-detachment member 60 at the part of the fitting protrusion 311 that protrudes from the internal rotating portion 32, the external rotating portion 31 and the internal rotating portion 32 are prevented from moving in the axial direction to prevent the internal rotating portion 32 from being separated or falling off from the external rotating portion 31. More specifically, the fitting protrusion 311 protrudes from the inner surface of the external rotating portion 31 and extends towards the internal rotating portion 32. The part of the fitting protrusion 311 extending to the fitting hole 32a is non-circular, and the part of the fitting protrusion 311 extending to be exposed from the fitting hole 32a is circular, and the anti-detachment member 60 fits with the circular fitting protrusion 311. In some embodiments of the present application, the anti-detachment member 60 is configured as an E-type circlip.

According to some embodiments of the present application, as shown in FIGS. 5 to 9, one of the internal rotating portion 32 and the ratchet 40 is provided with a hook portion, the other thereof is provided with a stop surface 42, and the hook portion is hooked on the stop surface 42. Specifically, due to the fit between the fitting protrusion 322 and the fitting groove 41 and the fit between the first driving portion 321 and the swing arm 41, the ratchet 40 can move together with the internal rotating portion 32. In order to prevent the ratchet 40 from being detached from the knob along the axial direction when the user rotates the knob 30, a hook portion 323 and a stop surface 42 are arranged on the ratchet 40 and the internal rotating portion 32, and the hook portion 323 may fit with and the stop surface 42 via snap connection. More specifically, the hook portion 323 can be slidably engaged with the stop surface 42, so that the ratchet 40 is fixed by the internal rotating portion 32 in both the axial and radial directions, and the ratchet 40 can rotate together with the internal rotating portion 32 and will not fall out of the internal rotating portion 32.

In some embodiments of the present application, as shown in FIGS. 1-12, the adjustment device 1 is provided with a housing 10 and bands 20. The band 20 penetrates the housing 10, on which a rack is formed that extends along the length direction. Two bands 20 have the same structure and are overlapped with each other.

The adjustment device 1 is also provided with a knob 30 and an anti-detachment member 60. The knob 30 includes an external rotating portion 31 and an internal rotating portion 32. The outer surface of the external rotating portion 31 is flush with the outer surface of the housing 10. The inner surface of the external rotating portion 31 is provided with a fitting protrusion 311. The part of the fitting protrusion 311 close to the inner surface of the external rotating portion 31 is a non-circular post, and the part of the fitting protrusion 311 away from the inner surface of the external rotating portion 31 is a circular post. The internal rotating portion 32 has two surfaces opposite to each other. One side surface of the internal rotating portion 32 is in contact with the external rotating portion 31. The other side surface of the internal rotating portion 32 is formed with a first driving portion 321, a fitting protrusion 322 and a hook portion. 323, the internal rotating portion 32 is also formed with a non-circular fitting hole 32a that fits with the non-circular fitting protrusion 311. At this time, the movement of the internal rotating portion 32 in the radial direction is consistent with the movement of the external rotating portion 31. The anti-detachment member 60 is an E-type circlip. The E-type circlip fits with the circular fitting protrusion 311 and is in contact with the other side surface of the internal rotating portion 32. At this time, the internal rotating portion 32 cannot move in the axial direction.

The adjustment device 1 is also provided with a ratchet 40 and a gear 50. The ratchet 40 is provided with a fitting groove 41a, and the fitting groove 41a is in clearance fit with the fitting protrusion 322. The ratchet 40 can be mounted at the internal rotating portion 32, at this time the movement of the ratchet 40 in the radial direction is consistent with the movement of the internal rotating portion 32. The ratchet 40 is also provided with a stop surface 42, and the hook portion 323 is slidably engaged with the stop surface 42. At this time, the ratchet 40 cannot move in the axial direction. The ratchet 40 is also provided with a swing arm 41. After the ratchet 40 is mounted on the internal rotating portion 32, the first driving portion 321 is located between the swing arm 41 and the inner ring gear 11 of the housing 10. The swing arm 41 is provided with ratchet teeth 411. The ratchet teeth 411 can selectively fit with the inner ring gear 11, and the first driving portion 321 can selectively contact and drive the swing arm 41 to move. The ratchet 40 is also provided with a non-circular fitting hole 32a, and the gear 50 is provided with a non-circular fitting post 51. The non-circular fitting hole 32a fits with the non-circular fitting post 51. At this time, the ratchet 40 can rotate synchronously with the gear 50. The gear 50 is connected to the two overlapped bands 20 respectively, and the gear 50 meshes with the fitting rack 21 on the band 20.

When the user rotates the external rotating portion 31 in the first direction, the internal rotating portion 32 rotates synchronously with the external rotating portion 31. At this time, the fitting protrusion 322 moves inside the fitting groove 41a, the ratchet teeth 411 of the ratchet 40 fit with and the inner ring gear 11, and the ratchet 40 cannot rotate in the first direction until the internal rotating portion 32 rotates to the first driving portion 321 to contact the swing arm 41 of the ratchet 40. The first driving portion 321 presses the swing arm 41 in the radial direction to cause the ratchet teeth 411 to be separated from the inner ring gear 11. At this time, the ratchet 40, driven by the fitting protrusion 322, can rotate synchronously with the internal rotating portion 32, the gear 50 also rotates synchronously with the ratchet 40, and the two bands 20 move towards each other.

When the user stops rotating the external rotating portion 31, the ratchet 411 fits with the inner ring gear 11, the ratchet 40 and the gear 50 cannot rotate, the two bands 20 no longer move, and the area of the wearing space remains unchanged.

When the user rotates the external rotating portion 31 in the second direction, the internal rotating portion 32 rotates synchronously with the external rotating portion 31. At this time, the fitting protrusion 322 moves inside the fitting groove 41a, and the ratchet teeth 411 of the ratchet 40 fit with the inner ring gear 11, and the ratchet 40 cannot rotate until the internal rotating portion 32 rotates to the first driving portion 321 to contact the ratchet 40 and/or fit protrusion 322 to stop against the side wall of the fitting groove 41a. At this time, the ratchet 40, driven by the first driving portion 321 and/or the fitting protrusion 322, can rotate synchronously with the internal rotating portion 32, the gear 50 also rotates synchronously with the ratchet 40, and the two bands 20 move away from each other.

The adjustment device 1 according to the embodiments of the present application arranges the knob 30 inside the housing 10, which greatly reduces the space occupied by the adjustment device 1 and beautifies the appearance of the adjustment device 1; the user can adjust the area of the wearing space simply by operating the external rotating portion 31 of the knob 30, which operation is simple and easy to use; by arranging the ratchet 40 and the first driving portion 321, the adjustment device 1 can have a locking function to prevent the band 20 from moving on its own so that area of the wearing space is changed. The structure is more reliable.

In some embodiments of the present application, as shown in FIGS. 7-8, the ratchet 40 has three swing arms 41 in the circumferential direction, each of which is provided with ratchet tooth 411 and a fitting groove 41a. A stop surface 42 is further formed on the inner side of each swing arm 41. As shown in FIG. 5, three first driving portions 321, three fitting protrusions 322 and three hook portions 323 are respectively formed on the other side surface of the internal rotating portion 32.

The following is a brief description of a head-mounted device according to the present application.

The head-mounted device according to the present application is provided with the adjustment device 1 of the above embodiments. With the adjustment device 1 of the above-mentioned embodiments, the head-mounted device of the present application occupies a small space and has a beautiful appearance. The wearing dimensions of the head-mounted device can be adjusted according to different needs of different users, which is easy to operate. Furthermore, the head-mounted device is suitable for users of various ages.

In the description of this specification, the description with reference to the terms “an embodiment,” “some embodiments,” “example,” “specific example,” or “some examples” are intended to mean that the specific features, structures, or materials described in connection with the embodiment or example are included in at least one embodiment or example of the present application. In this specification, schematic expressions of the above terms do not necessarily refer to the same embodiments or examples. Furthermore, the specific features, structures, materials or characteristics described may be combined in any suitable manner in any one or more embodiments or examples. In addition, those skilled in the art can join and combine the different embodiments or examples described in this specification.

Although the embodiments of the present application have been shown and described above, changes, modifications, substitutions and variations may be made to the embodiments described above.

1. An adjustment device, comprising:
a housing, provided with a mounting space and an inner ring gear;
two bands, movably arranged on the housing respectively and fitting with the housing to define a wearing space, each of the bands being provided with a fitting rack;
a knob, rotatably mounted inside the mounting space and provided with a first driving portion;
a ratchet and a gear, the ratchet and the gear rotating synchronously and both rotatably arranged on the knob, the gear meshing with the fitting rack on the two bands to drive the bands to move away from or towards each other, the ratchet being provided with a swing arm that is provided with ratchet teeth;
when the knob rotates in a first direction, the first driving portion drives the swing arm to move to detach the ratchet teeth from the inner ring gear, and the knob drives the ratchet to rotate; and
when the knob rotates in a second direction opposite to the first direction, the ratchet teeth fit with the inner ring gear, and the knob drives the ratchet to rotate.

2. The adjustment device according to claim 1, wherein an outer surface of the knob is no higher than an outer surface of the housing.

3. The adjustment device according to claim 1, wherein a fitting protrusion is arranged on the knob, a fitting groove is arranged on the ratchet, and the fitting protrusion protrudes into the fitting groove to drive the ratchet to rotate.

4. The adjustment device according to claim 1, wherein each of the bands is provided with a long hole, the long hole penetrates the band in a thickness direction of the band and extends in a length direction of the band, and the fitting rack is arranged on an inner wall of the long hole.

5. The adjustment device according to claim 1, wherein the ratchet is provided with a non-circular assembling hole, the gear is provided with a non-circular fitting post, and the fitting post fits with the assembling hole to cause the gear and the ratchet to rotate synchronously.

6. The adjustment device according to claim 1, wherein the knob comprises an external rotating portion and an internal rotating portion, the external rotating portion is rotatably arranged inside the mounting space, the internal rotating portion and the external rotating portion rotate synchronously, a part of the housing is clamped between the external rotating portion and the internal rotating portion, and the first driving portion is arranged on the internal rotating portion.

7. The adjustment device according to claim 6, wherein the external rotating portion is provided with a fitting protrusion that extends inwardly, at least a part of the fitting protrusion is non-circular, the internal rotating portion is provided with a non-circular fitting hole, and the fitting protrusion fits with the fitting hole to cause the external rotating portion and the internal rotating portion to rotate synchronously.

8. The adjustment device according to claim 7, further comprising an anti-detachment member that fits with the fitting protrusion and is located on an inner side of the internal rotating portion to prevent the internal rotating portion from falling off.

9. The adjustment device according to claim 6, wherein one of the internal rotating portion and the ratchet is provided with a hook portion, and the other of the internal rotating portion and the ratchet is provided with a stop surface, the hook portion is hooked on the stop surface.

10. A head-mounted device, comprising an adjustment device, the adjustment device comprising:
a housing, provided with a mounting space and an inner ring gear;
two bands, movably arranged on the housing respectively and fitting with the housing to define a wearing space, each of the bands being provided with a fitting rack;
a knob, rotatably mounted inside the mounting space and provided with a first driving portion;
a ratchet and a gear, the ratchet and the gear rotating synchronously and both rotatably arranged on the knob, the gear meshing with the fitting rack on the two bands to drive the bands to move away from or towards each other, the ratchet being provided with a swing arm that is provided with ratchet teeth;
when the knob rotates in a first direction, the first driving portion drives the swing arm to move to detach the ratchet teeth from the inner ring gear, and the knob drives the ratchet to rotate; and
when the knob rotates in a second direction opposite to the first direction, the ratchet teeth fit with the inner ring gear, and the knob drives the ratchet to rotate.

11. The head-mounted device according to claim 10, wherein an outer surface of the knob is no higher than an outer surface of the housing.

12. The head-mounted device according to claim 10, wherein a fitting protrusion is arranged on the knob, a fitting groove is arranged on the ratchet, and the fitting protrusion protrudes into the fitting groove to drive the ratchet to rotate.

13. The head-mounted device according to claim 10, wherein each of the bands is provided with a long hole, the long hole penetrates the band in a thickness direction of the band and extends in a length direction of the band, and the fitting rack is arranged on an inner wall of the long hole.

14. The head-mounted device according to claim 10, wherein the ratchet is provided with a non-circular assembling hole, the gear is provided with a non-circular fitting post, and the fitting post fits with the assembling hole to cause the gear and the ratchet to rotate synchronously.

15. The head-mounted device according to claim 10, wherein the knob comprises an external rotating portion and an internal rotating portion, the external rotating portion is rotatably arranged inside the mounting space, the internal rotating portion and the external rotating portion rotate synchronously, a part of the housing is clamped between the external rotating portion and the internal rotating portion, and the first driving portion is arranged on the internal rotating portion.

16. The head-mounted device according to claim 15, wherein the external rotating portion is provided with a fitting protrusion that extends inwardly, at least a part of the fitting protrusion is non-circular, the internal rotating portion is provided with a non-circular fitting hole, and the fitting protrusion fits with the fitting hole to cause the external rotating portion and the internal rotating portion to rotate synchronously.

17. The head-mounted device according to claim 16, the adjustment device further comprising an anti-detachment member that fits with the fitting protrusion and is located on an inner side of the internal rotating portion to prevent the internal rotating portion from falling off.

18. The head-mounted device according to claim 15, wherein one of the internal rotating portion and the ratchet is provided with a hook portion, and the other of the internal rotating portion and the ratchet is provided with a stop surface, the hook portion is hooked on the stop surface.

19. The head-mounted device according to claim 10, wherein the two bands have the same structure and are overlapped with each other.

20. The head-mounted device according to claim 19, wherein the gear is connected to the two overlapped bands respectively, and the gear meshes with the fitting rack on the band.
